(19) United States
(12) Patent Application Publication
(10) Pub. No.: US 2021/0389269 A1
(43) Pub. Date: Dec. 16, 2021

(54) SENSOR ELEMENT OF GAS SENSOR

(71) Applicant: NGK INSULATORS, LTD., Nagoya-shi (JP)

(72) Inventors: Ryo ONISHI, Iwakura-shi (JP); Yusuke WATANABE, Nagoya-shi (JP); Takashi HINO, Kasugai-shi (JP)

(21) Appl. No.: 17/460,763

(22) Filed: Aug. 30, 2021

Related U.S. Application Data
(63) Continuation of application No. PCT/JP2020/009603, filed on Mar. 6, 2020.

(30) Foreign Application Priority Data
Mar. 29, 2019 (JP) 2019-066820

(51) Int. Cl. G01N 27/407

(52) U.S. Cl. CPC G01N 27/4077; G01N 27/41; G01N 27/4071

(57) ABSTRACT

A leading-end protective layer of a sensor element includes: an inner layer covering a leading end surface and four side surfaces of an element base; and an outer layer covering the inner layer and having a lower porosity than the inner layer, and a film thickness variation degree, defined as a ratio of a difference between a maximum and a minimum value of total thicknesses of the leading-end protective layer at following positions with respect to an average value of the total thicknesses when the value is based at 100, is 20 or less: two positions to intersect with the protective layer, on planes passing through line intersections of an imaginary plane containing the end surface and imaginary planes containing main surfaces of the element base, and forming an angle of 45° with the former imaginary plane, and an intermediate position in an element thickness direction on the end surface.

### CROSS-REFERENCE TO RELATED APPLICATION

This application is a continuation application of PCT/JP2020/009603, filed on Mar. 6, 2020, which claims the benefit of priority of Japanese Patent Application No. 2019-066820, filed on Mar. 29, 2019, the entire contents of which are incorporated herein by reference.

### BACKGROUND OF THE INVENTION

### Field of the Invention

The present invention relates to a sensor element of a gas sensor and, in particular, to a surface protective layer thereof.

### Description of the Background Art

As a gas sensor for determining concentration of a desired gas component contained in a measurement gas, such as an exhaust gas from an internal combustion engine, a gas sensor that includes a sensor element made of an oxygen-ion conductive solid electrolyte, such as zirconia (ZrO₂), and including some electrodes on the surface and the inside thereof has been widely known. As the sensor element, a sensor element having an elongated planar shape and including a protective layer formed of a porous body (porous protective layer) in an end portion in which a part for introducing the measurement gas is provided has been known (see Japanese Patent No. 5344375, for example).

The protective layer is provided to the surface of the sensor element to secure water resistance of the sensor element when the gas sensor is in use. Specifically, the protective layer is provided to prevent water-induced cracking of the sensor element under the action of thermal shock caused by heat (cold) from water droplets adhering to the surface of the sensor element.

Adherence of water droplets to the surface of the sensor element is a phenomenon that could occur locally, so that, when uniformity of the thickness is insufficient, water-induced cracking may occur upon adherence of water droplets to a portion having a small thickness to cause thermal shock in the portion, even if the protective layer has an average thickness (film thickness) sufficient to suppress water-induced cracking.

In particular, at the vicinity of a corner of an end surface and a main surface of the sensor element on a side where a gas inlet is provided, it is confirmed that the thickness of the protective layer is likely to vary compared with the other portion, and thus water-induced cracking is more likely to occur.

### SUMMARY

The present invention relates to a sensor element of a gas sensor and, in particular, to a surface protective layer thereof.

According to the present invention, a sensor element of a gas sensor includes: an element base being a ceramic structure including, on an inside thereof, a sensing part to sense a gas component to be measured and having a leading end surface in which a gas inlet for introducing a measurement gas containing the gas component to be measured into the inside is provided; and a leading-end protective layer being a porous layer disposed around an outer periphery of the element base in a predetermined range from the leading end surface. The leading-end protective layer includes: an inner leading-end protective layer disposed to cover the leading end surface and four side surfaces of the element base contiguous with the leading end surface; and an outer leading-end protective layer disposed to cover the inner leading-end protective layer, and having a lower porosity than the inner leading-end protective layer, and a film thickness variation degree is 20 or less, where the film thickness variation degree is defined as a ratio of a difference between a maximum value and a minimum value of total thicknesses of the leading-end protective layer at three end portion total thickness evaluation positions with respect to an end portion total thickness representative value when the value is based at 100, the end portion total thickness representative value defined as an average value of the total thicknesses at the three end portion total thickness evaluation positions, the three end portion total thickness evaluation positions include a first position, a second position, and a third position defined in a cross section in a thickness direction along an element longitudinal direction at a center in a width direction of the sensor element, the first position being a position to intersect with the leading-end protective layer, on a plane passing through a line intersection of an imaginary plane containing the leading end surface and an imaginary plane containing one of main surfaces of the element base, and forming an angle of 45° with the imaginary plane containing the leading end surface, the second position being an intermediate position in an element thickness direction on the leading end surface, and the third position being a position to intersect with the leading-end protective layer, on a plane passing through a line intersection of the imaginary plane containing the leading end surface and an imaginary plane containing the other one of the main surfaces of the element base, and forming an angle of 45° with the plane containing the leading end surface.

According to the present invention, the sensor element in which water resistance of the leading-end protective layer in an end portion in which the gas inlet is provided is suitably secured is achieved.

It is therefore an object to provide a sensor element of a gas sensor in which the occurrence of water-induced cracking is more surely suppressed by securing uniformity of the thickness of a protective layer at an end surface of the sensor element on a side where a gas inlet is provided.

### BRIEF DESCRIPTION OF THE DRAWINGS

FIG. 1 is a schematic external perspective view of a sensor element 10.

FIG. 2 is a schematic view illustrating a configuration of a gas sensor 100 including a sectional view taken along a longitudinal direction of the sensor element 10.

FIG. 3 is a flowchart of processing at the manufacture of the sensor element 10.

FIG. 4 is a plot of leading-end water resistance against a film thickness variation degree.

### DESCRIPTION OF THE PREFERRED EMBODIMENTS

<Overview of Sensor Element and Gas Sensor>

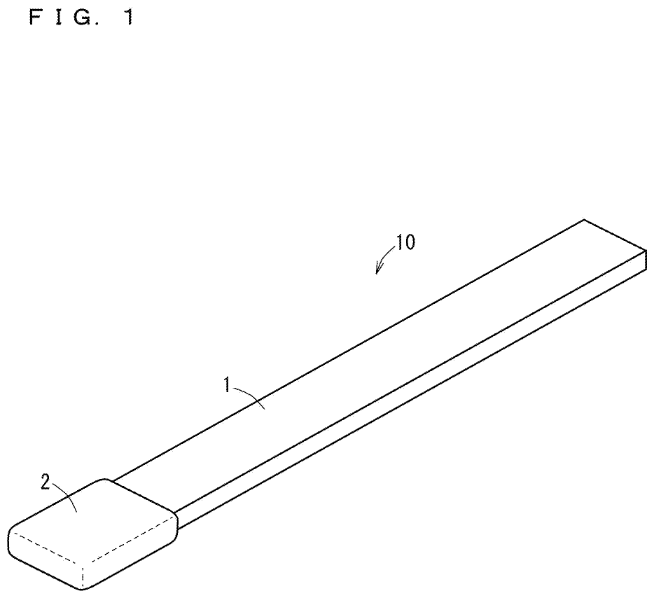

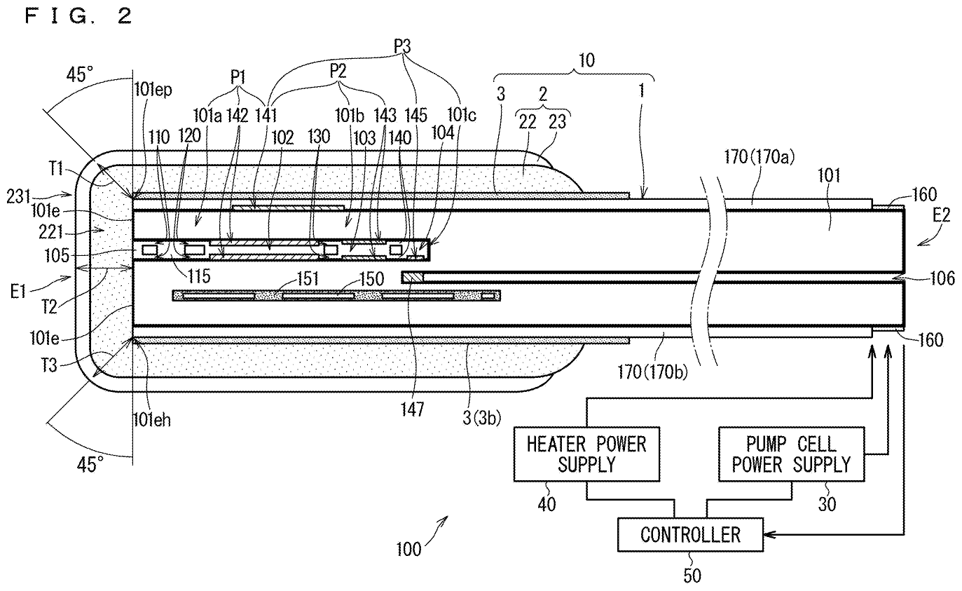

FIG. 1 is a schematic external perspective view of a sensor element (gas sensor element) 10 according to an embodiment of the present invention. FIG. 2 is a schematic view illustrating a configuration of a gas sensor 100 including a sectional view taken along a longitudinal direction of the sensor element 10. The sensor element 10 is a ceramic structure as a main component of the gas sensor 100 sensing a predetermined gas component in a measurement gas, and measuring concentration thereof. The sensor element 10 is a so-called limiting current gas sensor element.

In addition to the sensor element 10, the gas sensor 100 mainly includes a pump cell power supply 30, a heater power supply 40, and a controller 50.

As illustrated in FIG. 1, the sensor element 10 has a configuration in which one end portion of an elongated planar element base 1 is covered with a porous leading-end protective layer 2.

As illustrated in FIG. 2, the element base 1 includes an elongated planar ceramic body 101 as a main structure, main surface protective layers 170 are provided on two main surfaces of the ceramic body 101, and, in the sensor element 10, the leading-end protective layer 2 is further provided outside both an end surface (a leading end surface 101e of the ceramic body 101) and four side surfaces in one leading end portion. The four side surfaces other than opposite end surfaces in the longitudinal direction of the sensor element 10 (or the element base 1, or the ceramic body 101) are hereinafter simply referred to as side surfaces of the sensor element 10 (or the element base 1, or the ceramic body 101).

The ceramic body 101 is made of ceramic containing, as a main component, zirconia (yttrium stabilized zirconia), which is an oxygen-ion conductive solid electrolyte. Various components of the sensor element 10 are provided outside and inside the ceramic body 101. The ceramic body 101 having the configuration is dense and airtight. The configuration of the sensor element 10 illustrated in FIG. 2 is just an example, and a specific configuration of the sensor element 10 is not limited to this configuration.

The sensor element 10 illustrated in FIG. 2 is a so-called serial three-chamber structure type gas sensor element including a first internal chamber 102, a second internal chamber 103, and a third internal chamber 104 inside the ceramic body 101. That is to say, in the sensor element 10, the first internal chamber 102 communicates, through a first diffusion control part 110 and a second diffusion control part 120, with a gas inlet 105 opening to the outside on a side of one end portion E1 of the ceramic body 101 (to be precise, communicating with the outside through the leading-end protective layer 2), the second internal chamber 103 communicates with the first internal chamber 102 through a third diffusion control part 130, and the third internal chamber 104 communicates with the second internal chamber 103 through a fourth diffusion control part 140. A path from the gas inlet 105 to the third internal chamber 104 is also referred to as a gas distribution part. In the sensor element 10 according to the present embodiment, the gas distribution part is provided straight along the longitudinal direction of the ceramic body 101.

The first diffusion control part 110, the second diffusion control part 120, the third diffusion control part 130, and the fourth diffusion control part 140 are each provided as two slits vertically arranged in FIG. 2. The first diffusion control part 110, the second diffusion control part 120, the third diffusion control part 130, and the fourth diffusion control part 140 provide predetermined diffusion resistance to a measurement gas passing therethrough. A buffer space 115 having an effect of buffering pulsation of the measurement gas is provided between the first diffusion control part 110 and the second diffusion control part 120.

An outer pump electrode 141 is provided on an outer surface of the ceramic body 101, and an inner pump electrode 142 is provided in the first internal chamber 102. Furthermore, an auxiliary pump electrode 143 is provided in the second internal chamber 103, and a measurement electrode 145 as a sensing part to directly sense a gas component to be measured is provided in the third internal chamber 104. In addition, a reference gas inlet 106 which communicates with the outside and through which a reference gas is introduced is provided on a side of the other end portion E2 of the ceramic body 101, and a reference electrode 147 is provided in the reference gas inlet 106.

In a case where a target of measurement of the sensor element 10 is NOx in the measurement gas, for example, concentration of a NOx gas in the measurement gas is calculated by a process as described below.

First, the measurement gas introduced into the first internal chamber 102 is adjusted to have a substantially constant oxygen concentration by a pumping action (pumping in or out of oxygen) of a main pump cell P1, and then introduced into the second internal chamber 103. The main pump cell P1 is an electrochemical pump cell including the outer pump electrode 141, the inner pump electrode 142, and a ceramic layer 101a that is a portion of the ceramic body 101 existing between these electrodes. In the second internal chamber 103, oxygen in the measurement gas is pumped out of the element by a pumping action of an auxiliary pump cell P2, which is also an electrochemical pump cell, so that the measurement gas is at a sufficiently low oxygen partial pressure. The auxiliary pump cell P2 includes the outer pump electrode 141, the auxiliary pump electrode 143, and a ceramic layer 101b that is a portion of the ceramic body 101 existing between these electrodes.

The outer pump electrode 141, the inner pump electrode 142, and the auxiliary pump electrode 143 are each formed as a porous cermet electrode (e.g., a cermet electrode made of ZrO₂ and Pt that contains Au of 1%). The inner pump electrode 142 and the auxiliary pump electrode 143 to be in contact with the measurement gas are each formed using a material having weakened or no reducing ability with respect to a NOx component in the measurement gas.

NOx in the measurement gas caused by the auxiliary pump cell P2 to be at a low oxygen partial pressure is introduced into the third internal chamber 104, and reduced or decomposed by the measurement electrode 145 provided in the third internal chamber 104. The measurement electrode 145 is a porous cermet electrode also functioning as a NOx reduction catalyst that reduces NOx existing in an atmosphere in the third internal chamber 104. During the reduction or decomposition, a potential difference between the measurement electrode 145 and the reference electrode 147 is maintained constant. Oxygen ions generated by the above-mentioned reduction or decomposition are pumped out of the element by a measurement pump cell P3. The measurement pump cell P3 includes the outer pump electrode 141, the measurement electrode 145, and a ceramic layer 101c that is a portion of the ceramic body 101 existing between these electrodes. The measurement pump cell P3 is an electrochemical pump cell pumping out oxygen generated by decomposition of NOx in an atmosphere around the measurement electrode 145.

Pumping (pumping in or out of oxygen) of the main pump cell P1, the auxiliary pump cell P2, and the measurement pump cell P3 is achieved, under control performed by the controller 50, by the pump cell power supply (variable power supply) 30 applying a voltage necessary for pumping across electrodes included in each of the pump cells. In a case of the measurement pump cell P3, a voltage is applied across the outer pump electrode 141 and the measurement electrode 145 so that the potential difference between the measurement electrode 145 and the reference electrode 147 is maintained at a predetermined value. The pump cell power supply 30 is typically provided for each pump cell.

The controller 50 detects a pump current Ip2 flowing between the measurement electrode 145 and the outer pump electrode 141 in accordance with the amount of oxygen pumped out by the measurement pump cell P3, and calculates a NOx concentration in the measurement gas based on a linear relationship between a current value (NOx signal) of the pump current Ip2 and the concentration of decomposed NOx.

The gas sensor 100 preferably includes a plurality of electrochemical sensor cells, which are not illustrated, sensing the potential difference between each pump electrode and the reference electrode 147, and each pump cell is controlled by the controller 50 based on a signal detected by each sensor cell.

In the sensor element 10, a heater 150 is buried in the ceramic body 101. The heater 150 is provided, below the gas distribution part in FIG. 2, over a range from the vicinity of the one end portion E1 at least to a position of formation of the measurement electrode 145 and the reference electrode 147. The heater 150 is provided mainly to heat the sensor element 10 to enhance oxygen-ion conductivity of the solid electrolyte forming the ceramic body 101 when the sensor element 10 is in use. More particularly, the heater 150 is provided to be surrounded by an insulating layer 151.

The heater 150 is a resistance heating body made, for example, of platinum. The heater 150 generates heat by being powered from the heater power supply 40 under control performed by the controller 50.

The sensor element 10 according to the present embodiment is heated by the heater 150 when being in use so that the temperature at least in a range from the first internal chamber 102 to the second internal chamber 103 is at or above 500° C. In some cases, the sensor element 10 is heated so that the temperature of the gas distribution part as a whole from the gas inlet 105 to the third internal chamber 104 is at or above 500° C. These are to enhance the oxygen-ion conductivity of the solid electrolyte forming each pump cell and to desirably demonstrate the ability of each pump cell. In this case, the temperature in the vicinity of the first internal chamber 102, which is at the highest temperature, is approximately at 700° C. to 800° C.

In the following description, from among the two main surfaces of the ceramic body 101, a main surface (or an outer surface of the sensor element 10 having the main surface) which is located on an upper side in FIG. 2 and on a side where the main pump cell P1, the auxiliary pump cell P2, and the measurement pump cell P3 are mainly provided is also referred to as a pump surface, and a main surface (or an outer surface of the sensor element 10 having the main surface) which is located on a lower side in FIG. 2 and on a side where the heater 150 is provided is also referred to as a heater surface. In other words, the pump surface is a main surface closer to the gas inlet 105, the three internal chambers, and the pump cells than to the heater 150, and the heater surface is a main surface closer to the heater 150 than to the gas inlet 105, the three internal chambers, and the pump cells.

A plurality of electrode terminals 160 are formed on the respective main surfaces of the ceramic body 101 on the side of the other end portion E2 to establish electrical connection between the sensor element 10 and the outside. These electrode terminals 160 are electrically connected to the above-mentioned five electrodes, opposite ends of the heater 150, and a lead for detecting heater resistance, which is not illustrated, through leads provided inside the ceramic body 101, which are not illustrated, to have a predetermined correspondence relationship. Application of a voltage from the pump cell power supply 30 to each pump cell of the sensor element 10 and heating by the heater 150 by being powered from the heater power supply 40 are thus performed through the electrode terminals 160.

The sensor element 10 further includes the above-mentioned main surface protective layers 170 (170a and 170b) on the pump surface and the heater surface of the ceramic body 101. The main surface protective layers 170 are layers made of alumina, having a thickness of approximately 5 μm to 30 μm, and including pores with a porosity of approximately 20% to 40%, and are provided to prevent adherence of any foreign matter and poisoning substances to the main surfaces (the pump surface and the heater surface) of the ceramic body 101 and the outer pump electrode 141 provided on the pump surface. The main surface protective layer 170a on the pump surface thus functions as a pump electrode protective layer for protecting the outer pump electrode 141.

In the present embodiment, the porosity is obtained by applying a known image processing method (e.g., binarization processing) to a scanning electron microscope (SEM) image of an evaluation target.

The main surface protective layers 170 are provided over substantially all of the pump surface and the heater surface except that the electrode terminals 160 are partially exposed in FIG. 2, but this is just an example. The main surface protective layers 170 may locally be provided in the vicinity of the outer pump electrode 141 on the side of the one end portion E1 compared with the case illustrated in FIG. 2.

<Details of Leading-End Protective Layer>

In the sensor element 10, the leading-end protective layer 2 is provided around an outermost periphery of the element base 1 having a configuration as described above in a predetermined range from the one end portion E1.

The leading-end protective layer 2 is provided in a manner of surrounding a portion of the element base 1 in which the temperature is high (up to approximately 700° C. to 800° C.) when the gas sensor 100 is in use, in order to secure water resistance in the portion to thereby suppress the occurrence of cracking (water-induced cracking) of the element base 1 due to thermal shock caused by local temperature reduction upon direct exposure of the portion to water.

In addition, the leading-end protective layer 2 is provided to secure poisoning resistance to prevent poisoning substances, such as Mg, from entering into the sensor element 10.

As illustrated in FIG. 2, in the sensor element 10 according to the present embodiment, the leading-end protective layer 2 includes two layers: an inner leading-end protective layer 22 and an outer leading-end protective layer 23. An underlying layer 3 is provided between the leading-end protective layer 2 (inner leading-end protective layer 22) and the element base 1.

The underlying layer 3 is a layer provided to secure bonding (adhesion) of the inner leading-end protective layer 22 formed thereon (further the outer leading-end protective layer 23). The underlying layer 3 is provided at least on two main surfaces of the element base 1 on a side of the pump surface and a side of the heater surface. That is to say, the underlying layer 3 includes an underlying layer 3a on the side of the pump surface and an underlying layer 3b on the side of the heater surface. The underlying layer 3, however, is not provided on a side of the leading end surface 101e of the ceramic body 101 (of the element base 1).

The underlying layer 3 is made of alumina, has a porosity of 30% to 60%, and has a thickness of 15 μm to 50 μm. In contrast to the inner leading-end protective layer 22 and the outer leading-end protective layer 23, the underlying layer 3 is formed along with the element base 1 in a process of manufacturing the element base 1 as described below.

The inner leading-end protective layer 22 and the outer leading-end protective layer 23 are provided in this order from inside to cover the leading end surface 101e and the four side surfaces on the side of the one end portion E1 of the element base 1 (around an outer periphery of the element base 1 on the side of the one end portion E1). A portion of the inner leading-end protective layer 22 on the side of the leading end surface 101e is particularly referred to as a leading-end portion 221, and a portion of the inner leading-end protective layer 22 on the side of the pump surface and the side of the heater surface is particularly referred to as a main surface portion 222. Similarly, a portion of the outer leading-end protective layer 23 on the side of the leading end surface 101e is particularly referred to as a leading-end portion 231, and a portion of the outer leading-end protective layer 23 on the side of the pump surface and the side of the heater surface is particularly referred to as a main surface portion 232. The main surface portion 222 of the inner leading-end protective layer 22 is adjacent to the underlying layer 3.

The inner leading-end protective layer 22 is made of alumina, has a porosity of 40% to 80%, and has a thickness of 300 μm to 800 μm. The outer leading-end protective layer 23 is made of alumina, has a porosity of 10% to 40%, which is lower than that of the inner leading-end protective layer 22, and has a thickness of 50 μm to 300 μm. The leading-end protective layer 2 thereby has a configuration in which the inner leading-end protective layer 22 having lower thermal conductivity than the outer leading-end protective layer 23 is covered with the outer leading-end protective layer 23 having a lower porosity than the inner leading-end protective layer 22. The inner leading-end protective layer 22 is provided as a layer having low thermal conductivity to have a function to suppress heat conduction from the outside to the element base 1.

The inner leading-end protective layer 22 and the outer leading-end protective layer 23 are formed by sequentially thermal spraying (plasma-spraying) materials for them with respect to the element base 1 having a surface on which the underlying layer 3 has been formed. This is to develop an anchoring effect between the inner leading-end protective layer 22 and the underlying layer 3 formed in advance in the process of manufacturing the element base 1 to thereby secure bonding (adhesion) of the inner leading-end protective layer 22 (including the outer leading-end protective layer 23 formed outside the inner leading-end protective layer 22) to the underlying layer 3. In other words, the underlying layer 3 has a function to secure bonding (adhesion) of the inner leading-end protective layer 22.

In the present embodiment, an end portion total thickness representative value is specified for a total thickness (hereinafter, an end portion total thickness) of the leading-end protective layer 2 on the side of the one end portion E1 of the sensor element 10, and the leading-end protective layer 2 is provided so that a film thickness variation degree calculated using the end portion total thickness representative value is 20 or less on the side of the one end portion E1 of the sensor element 10.

The end portion total thickness representative value is herein defined as an average value of end portion total thicknesses of a portion of the leading-end protective layer 2 formed on the side of the one end portion E1 (the leading-end portion 221 of the inner leading-end protective layer 22 and the leading-end portion 231 of the outer leading-end protective layer 23) at three different thickness evaluation positions (Pos. 1, Pos. 2, and Pos. 3) defined in a vertical cross section (cross section in a thickness direction) along an element longitudinal direction at the center in a width direction of the sensor element 10. Specifically, the positions Pos. 1, Pos. 2, and Pos. 3 are defined as described below.

First, the Pos. 1 is a position to intersect with the leading-end protective layer 2, on a plane passing through a line intersection (typically, an edge 101ep of the leading end surface 101e on the side of the pump surface) of an imaginary plane containing the leading end surface 101e and an imaginary plane containing the pump surface, and forming an angle of 45° with the imaginary plane containing the leading end surface 101e.

The Pos. 1 corresponds to a position of a boundary between the side of the one end portion E1 and the side of the pump surface of the leading-end protective layer 2.

The Pos. 2 is an intermediate position in an element thickness direction on the leading end surface 101e.

Furthermore, the Pos. 3 is a position to intersect with the leading-end protective layer 2, on a plane passing through a line intersection (typically, an edge 101eh of the leading end surface 101e on the side of the heater surface) of the imaginary plane containing the leading end surface 101e and an imaginary plane containing the heater surface, and forming an angle of 45° with the imaginary plane containing the leading end surface 101e. The Pos. 3 corresponds to a position of a boundary between the side of the one end portion E1 and the side of the heater surface of the leading-end protective layer 2.

In FIG. 2, the end portion total thicknesses at these three positions are shown as T1, T2, and T3.

Depending on the sensor element 10, however, at least one of the edge 101ep on the side of the pump surface and the edge 101eh on the side of the heater surface is chamfered. The edge 101ep and/or the edge 101eh are/is not present in such a case, but the end portion total thickness(es) at the Pos. 1 and/or the Pos. 3 can be evaluated by following the above-mentioned definitions. When a chamfer is symmetrical with respect to the leading end surface 101e and the pump surface and/or the heater surface, for example, the end portion total thickness(es) at the Pos. 1 and/or the Pos. 3 are/is to be evaluated with a position of the center of the chamfer as a starting point.

The film thickness variation degree is defined as a ratio of a difference between a maximum value and a minimum value (maximum film thickness difference) of the end portion total thicknesses at the respective thickness evaluation positions to the end portion total thickness representative value when the value is based at 100.

The end portion total thicknesses at the three thickness evaluation positions can be obtained, for example, from a captured image of a cross section in the thickness direction of the sensor element 10 in which the thickness evaluation positions are defined. The end portion total thicknesses are each 1300 μm at most, which is the sum of a maximum value of the thickness of the inner leading-end protective layer 22 and a maximum value of the thickness of the outer leading-end protective layer 23.

The film thickness variation degree is a value indicative of uniformity of the end portion total thickness, and the leading-end protective layer 2 can be evaluated to have a nearly uniform thickness as the value of the film thickness variation degree is small.

The thickness evaluation positions include the Pos. 1 to Pos. 3 mainly for the following two reasons. First, the Pos. 1 and Pos. 3 each correspond to the position of the boundary between the side of the one end portion E1 and the side of the main surface (the pump surface or the heater surface) of the leading-end protective layer 2 so that the end portion total thickness is likely to vary at each of the positions when the leading-end protective layer 2 is formed by the above-mentioned method, while the Pos. 2 is a representative position on the leading end surface 101e of the leading-end protective layer 2, and the leading-end protective layer 2 is relatively easily formed to have an intended thickness at or around the position. It is thus considered to be appropriate to take the end portion total thicknesses at the Pos. 1 to Pos. 3 into account to evaluate a degree of uniformity of the thickness of the leading-end protective layer 2 on the side of the one end portion E1. Second, a portion of the leading-end protective layer 2 on the side of the one end portion E1 where the gas inlet 105 for introducing the measurement gas into the gas distribution part including the internal chambers is provided has lower strength than the other portion, and thus it is considered to be necessary to increase uniformity of the end portion total thickness to increase thermal shock resistance.

In the gas sensor 100 according to the present embodiment, the leading-end protective layer 2 is provided so that the film thickness variation degree for the end portion total thickness is 20 or less as described above to secure uniformity of the end portion total thickness. Uniformity of the end portion total thickness is secured as described above, so that the leading-end protective layer 2 uniformly has excellent thermal shock resistance on the side of the one end portion E1 of the sensor element 10. Thermal shock caused due to adherence of water droplets to a portion of the leading-end protective layer 2 locally having a small thickness on the side of the one end portion E1 of the sensor element 10 and resultant water-induced cracking of the sensor element 10 are thereby suitably suppressed. That is to say, in the gas sensor 100 according to the present embodiment, water resistance on the side of the one end portion E1 of the sensor element 10 has been improved.

The end portion total thickness representative value and further the film thickness variation degree are calculated using only the end portion total thickness at the center in the width direction, so that the total thickness at a position other than the center in the width direction on the side of the one end portion E1 of the leading-end protective layer 2 is not considered. When uniformity of the end portion total thickness at the center in the width direction of the leading-end protective layer 2 is obtained so that the film thickness variation degree is 20 or less, however, uniformity of the end portion total thickness at the other position in the width direction is actually secured, and the sensor element 10 has excellent water resistance on the side of the one end portion E1.

When the total thickness of the leading-end protective layer 2 on the side of the one end portion E1 of the sensor element 10 is uniform so that the film thickness variation degree for the end portion total thickness is 20 or less, cracking is less likely to occur when the sensor element 10 having been cooled to a room temperature with the end of use of the gas sensor 100 while condensed water adheres to the portion is heated up again by the heater 150 with the restart of use of the gas sensor 100. This is presumably because endotherm used for evaporation of adhering water is made uniform due to uniform total thickness of the portion.

The inner leading-end protective layer 22 and the outer leading-end protective layer 23 are provided not to cover the underlying layer 3 (3a and 3b) as a whole but to expose an end portion of the underlying layer 3 on a side opposite the side of the one end portion E1 in the longitudinal direction of the sensor element 10. This is to more surely secure bonding (adhesion) of the inner leading-end protective layer 22 (including the outer leading-end protective layer 23 formed outside the inner leading-end protective layer 22) to the underlying layer 3.

In addition, in the sensor element 10 shown in FIG. 2, the outer leading-end protective layer 23 is formed to expose an end portion of the inner leading-end protective layer 22 on a side opposite the side of the one end portion E1, but the outer leading-end protective layer 23 is not necessarily required to be formed in this manner. The outer leading-end protective layer 23 may be formed to cover the end portion of the inner leading-end protective layer 22.

As described above, in the sensor element 10 according to the present embodiment, the leading-end protective layer 2 has a two-layer structure including the inner leading-end protective layer 22 and the outer leading-end protective layer 23, the inner leading-end protective layer 22 with low thermal conductivity having a porosity in a range of 40% to 80% is surrounded by the outer leading-end protective layer 23 having a low porosity, and, further, the leading-end protective layer 2 is provided so that the film thickness variation degree on the side of the one end portion E1 of the sensor element 10 is 20 or less, so that uniformity of the thickness of the leading-end protective layer 2 on the side of the one end portion E1 of the sensor element 10 is secured, and the leading-end protective layer 2 uniformly has excellent thermal shock resistance on the side of the one end portion E1. With the configuration, water resistance on the side of the one end portion E1 has been suitably secured in the sensor element 10.

<Process of Manufacturing Sensor Element>

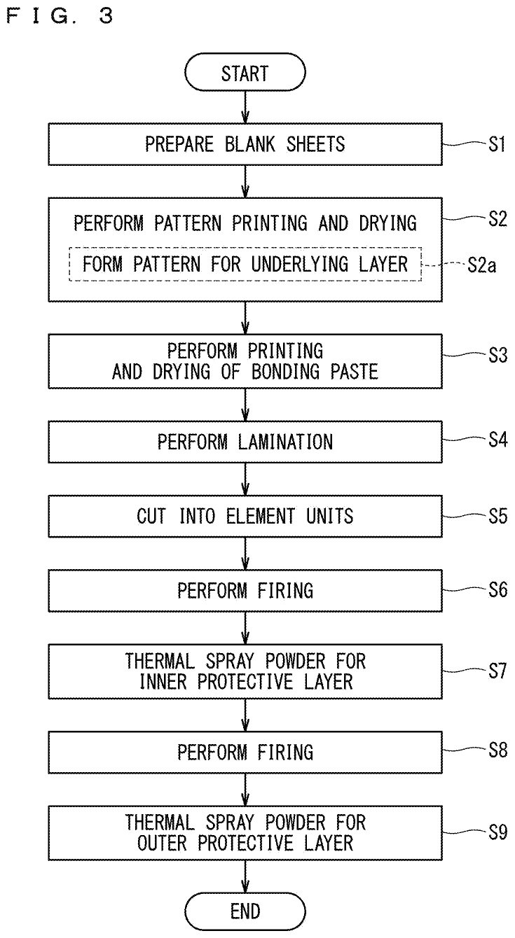

One example of a process of manufacturing the sensor element 10 having a configuration and features as described above will be described next. FIG. 3 is a flowchart of processing at the manufacture of the sensor element 10.

At the manufacture of the element base 1, a plurality of blank sheets (not illustrated) being green sheets containing the oxygen-ion conductive solid electrolyte, such as zirconia, as a ceramic component and having no pattern formed thereon are prepared first (step S1).

The blank sheets have a plurality of sheet holes used for positioning in printing and lamination. The sheet holes are formed to the blank sheets in advance prior to pattern formation through, for example, punching by a punching machine. Green sheets corresponding to a portion of the ceramic body 101 in which an internal space is formed also include penetrating portions corresponding to the internal space formed in advance through, for example, punching as described above. The blank sheets are not required to have the same thickness, and may have different thicknesses in accordance with corresponding portions of the element base 1 eventually formed.

After preparation of the blank sheets corresponding to the respective layers, pattern printing and drying are performed on the individual blank sheets (step S2). Specifically, a pattern of various electrodes, a pattern of the heater 150 and the insulating layer 151, a pattern of the electrode terminals 160, a pattern of the main surface protective layers 170, a pattern of internal wiring, which is not illustrated, and the like are formed. Application or placement of a sublimable material (vanishing material) for forming the first diffusion control part 110, the second diffusion control part 120, the third diffusion control part 130, and the fourth diffusion control part 140 is also performed at the time of pattern printing. In addition, a pattern to form the underlying layer 3 (3a and 3b) is printed onto blank sheets to become an uppermost layer and a lowermost layer after lamination (step S2a).

The patterns are printed by applying pastes for pattern formation prepared in accordance with the properties required for respective formation targets onto the blank sheets using known screen printing technology. At formation of the underlying layer 3, for example, an alumina paste that can form the underlying layer 3 having a desired porosity and thickness in the sensor element 10 eventually obtained is used. A known drying means can be used for drying after printing.

After pattern printing on each of the blank sheets, printing and drying of a bonding paste are performed to laminate and bond the green sheets (step S3). The known screen printing technology can be used for printing of the bonding paste, and the known drying means can be used for drying after printing.

The green sheets to which an adhesive has been applied are then stacked in a predetermined order, and the stacked green sheets are crimped under predetermined temperature and pressure conditions to thereby form a laminated body (step S4). Specifically, crimping is performed by stacking and holding the green sheets as a target of lamination on a predetermined lamination jig, which is not illustrated, while positioning the green sheets at the sheet holes, and then heating and pressurizing the green sheets together with the lamination jig using a lamination machine, such as a known hydraulic pressing machine. The pressure, temperature, and time for heating and pressurizing depend on a lamination machine to be used, and these conditions may be determined appropriately to achieve good lamination. The pattern to form the underlying layer 3 may be formed on the laminated body obtained in this manner.

After the laminated body is obtained as described above, the laminated body is cut out at a plurality of positions to obtain unit bodies eventually becoming the individual element bases 1 (step S5).

The unit bodies as obtained are then each fired at a firing temperature of approximately 1300° C. to 1500° C. (step S6). The element base 1 having main surfaces on which the underlying layer 3 is provided is thereby manufactured. That is to say, the element base 1 is generated by integrally firing the ceramic body 101 made of the solid electrolyte, the electrodes, and the main surface protective layers 170 along with the underlying layer 3. Integral firing is performed in this manner, so that the electrodes each have sufficient adhesion strength in the element base 1.

After the element base 1 is manufactured in the above-mentioned manner, the inner leading-end protective layer 22 and the outer leading-end protective layer 23 are formed with respect to the element base 1. The inner leading-end protective layer 22 is formed by thermal spraying powder (alumina powder) for forming the inner leading-end protective layer prepared in advance at a position of the element base 1 as a target of formation of the inner leading-end protective layer 22 to have an intended thickness (step S7), and then firing the element base 1 on which an applied film has been formed in the above manner (step S8). The alumina powder for forming the inner leading-end protective layer contains alumina powder having predetermined particle size distribution and a pore-forming material at a ratio corresponding to a desired porosity, and the pore-forming material is pyrolyzed by firing the element base 1 after thermal spraying to suitably form the inner leading-end protective layer 22 having a high porosity of 40% to 80%. Known technology is applicable to thermal spraying and firing.

Upon formation of the inner leading-end protective layer 22, powder (alumina powder) for forming the outer leading-end protective layer similarly prepared in advance and containing alumina powder having predetermined particle size distribution is thermal sprayed at a position of the element base 1 as a target of formation of the outer leading-end protective layer 23 to have an intended thickness (step S9) to thereby form the outer leading-end protective layer 23 having a desired porosity. The alumina powder for forming the outer leading-end protective layer does not contain the pore-forming material. Known technology is also applicable to the thermal spraying.

The inner leading-end protective layer 22 and/or the outer leading-end protective layer 23 may be polished after formation thereof to increase uniformity of the thickness of the leading-end protective layer 2. A polishing method is not particularly limited. When abrasive paper (sandpaper) is used, the paper having a grit size number of 150 or less is preferably used.

The sensor element 10 is obtained by the above-mentioned procedures. The sensor element 10 thus obtained is housed in a predetermined housing, and built into the body (not illustrated) of the gas sensor 100.

<Modifications>

The above-mentioned embodiment is targeted at a sensor element having three internal chambers, but the sensor element is not necessarily required to have a three-chamber structure. That is to say, the sensor element may have one internal chamber or two internal chambers.

In the above-mentioned embodiment, after thermal spraying of the powder for forming the inner leading-end protective layer in step S7, firing in step S8 is performed, and then thermal spraying of the powder for forming the outer leading-end protective layer in step S9 is performed, but firing in step S8 and thermal spraying in step S9 may be performed in reverse order.

In the above-mentioned embodiment, the inner leading-end protective layer 22 and the outer leading-end protective layer 23 are each made of alumina, and the alumina powder is used as a thermal spraying material when these layers are formed, but the inner leading-end protective layer 22 and the outer leading-end protective layer 23 may not be made of alumina. The inner leading-end protective layer 22 and the outer leading-end protective layer 23 may be provided using a metal oxide, such as zirconia (ZrO₂), spinel (MgAl₂O₄), and mullite (Al₆O₁₃Si₂), in place of alumina. In this case, powder of these metal oxides may be used as the thermal spraying material.

### EXAMPLES

Twelve types of sensor elements 10 (Samples Nos. 1 to 12) having different end portion total thicknesses were manufactured. Water resistance on the side of the one end portion E1 (leading-end water resistance) of each of the sensor elements 10 was evaluated.

Leading-end water resistance was evaluated by applying a water droplet of 0.1 μL at a time to the leading-end protective layer 2 on the side of the one end portion E1 of each of the sensor elements 10 while measuring the pump current through the main pump cell P1 with the sensor element 10 heated by the heater 150 to approximately 500° C. to 900° C., and specifying a maximum amount of water causing no abnormalities in an output of measurement.

It is considered that any abnormality occurs in the output of measurement in the evaluation because the leading-end protective layer 2 is subjected to thermal shock to cause cracking of the sensor element 10.

End portion total thicknesses at the three thickness evaluation positions Pos. 1, Pos. 2, and Pos. 3 of each of the sensor elements 10 were obtained from a cross-sectional SEM image, and the end portion total thickness representative value, the maximum film thickness difference, and the film thickness variation degree were calculated using the obtained values.

End portion total thicknesses at the Pos. 1, Pos. 2, and Pos. 3 (shown as “LEADING-END PROTECTIVE LAYER TOTAL FILM THICKNESS” in Table 1), the end portion total thickness representative value (shown as “Ave.” in Table 1) and the maximum film thickness difference obtained from the end portion total thicknesses, the film thickness variation degree calculated from the end portion total thickness representative value and the maximum film thickness difference, and results of evaluation of leading-end water resistance of each of the sensor elements 10 are shown in Table 1 as a list.

TABLE 1

| | LEADING-END PROTECTIVE | | | | MAXIMUM FILM | FILM | LEADING- |
|---|---|---|---|---|---|---|---|
| | LAYER TOTAL FILM | | | | THICKNESS | THICKNESS | END WATER |
| | THICKNESS [μm] | | | | DIFFERENCE | VARIATION | RESISTANCE |
| No. | Pos. 1 | Pos. 2 | Pos. 3 | Ave. | (Max-Min) [μm] | DEGREE | [μL] |
| 1 | 756.2 | 853.2 | 743.6 | 784.3 | 109.6 | 14.0 | 24.2 |
| 2 | 707.5 | 847.8 | 703.6 | 753.0 | 144.2 | 19.2 | 19.9 |
| 3 | 648.6 | 849.2 | 647.8 | 715.2 | 201.4 | 28.2 | 15.0 |
| 4 | 602.8 | 851.6 | 599.2 | 684.5 | 252.4 | 36.9 | 11.8 |
| 5 | 601.5 | 750.6 | 603.1 | 651.7 | 149.1 | 22.9 | 11.9 |
| 6 | 550.3 | 749.5 | 549.8 | 616.5 | 199.7 | 32.4 | 9.5 |
| 7 | 503.8 | 747.3 | 505.8 | 585.6 | 243.5 | 41.6 | 8.2 |
| 8 | 450.8 | 756.3 | 449.4 | 552.2 | 306.9 | 55.6 | 7.8 |
| 9 | 823.4 | 869.0 | 857.0 | 849.8 | 45.6 | 5.4 | 34.6 |
| 10 | 729.0 | 783.0 | 731.0 | 747.7 | 54.0 | 7.2 | 22.5 |
| 11 | 780.5 | 838.6 | 772.0 | 797.0 | 66.6 | 8.4 | 27.6 |
| 12 | 796.4 | 859.1 | 803.9 | 819.8 | 62.7 | 7.6 | 30.8 |

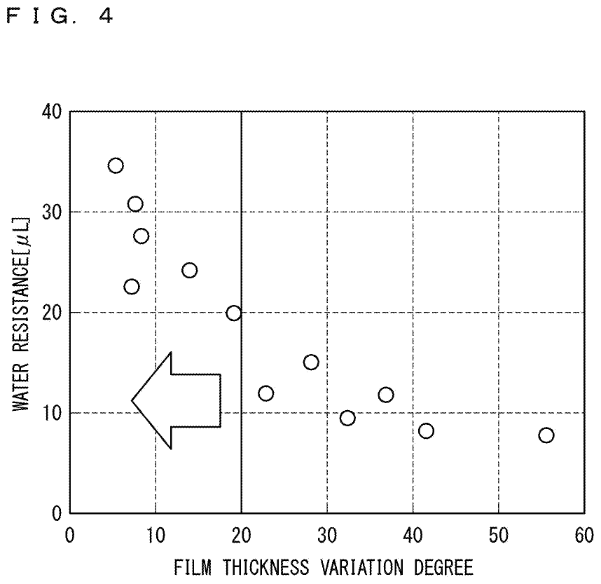

FIG. 4 is a plot of leading-end water resistance of each of the twelve types of sensor elements 10 shown in Table 1 against the film thickness variation degree.

It can be seen from Table 1 and FIG. 4 that there is a correlation between the film thickness variation degree and leading-end water resistance, and excellent leading-end water resistance of approximately 20 μL or more is achieved in the sensor element 10 in which the film thickness variation degree is 20 or less.

1. A sensor element of a gas sensor, the sensor element comprising:
an element base being a ceramic structure including, on an inside thereof, a sensing part to sense a gas component to be measured and having a leading end surface in which a gas inlet for introducing a measurement gas containing said gas component to be measured into said inside is provided; and
a leading-end protective layer being a porous layer disposed around an outer periphery of said element base in a predetermined range from said leading end surface, wherein
said leading-end protective layer includes:
an inner leading-end protective layer disposed to cover said leading end surface and four side surfaces of said element base contiguous with said leading end surface; and
an outer leading-end protective layer disposed to cover said inner leading-end protective layer, and having a lower porosity than said inner leading-end protective layer, and
a film thickness variation degree is 20 or less,
where said film thickness variation degree is defined as a ratio of a difference between a maximum value and a minimum value of total thicknesses of said leading-end protective layer at three end portion total thickness evaluation positions with respect to an end portion total thickness representative value when the value is based at 100, said end portion total thickness representative value defined as an average value of said total thicknesses at said three end portion total thickness evaluation positions,
said three end portion total thickness evaluation positions comprise a first position, a second position, and a third position defined in a cross section in a thickness direction along an element longitudinal direction at a center in a width direction of said sensor element,
said first position being a position to intersect with said leading-end protective layer, on a plane passing through a line intersection of an imaginary plane containing said leading end surface and an imaginary plane containing one of main surfaces of said element base, and forming an angle of 45° with said imaginary plane containing said leading end surface,
said second position being an intermediate position in an element thickness direction on said leading end surface, and
said third position being a position to intersect with said leading-end protective layer, on a plane passing through a line intersection of said imaginary plane containing said leading end surface and an imaginary plane containing the other one of said main surfaces of said element base, and forming an angle of 45° with said plane containing said leading end surface.

2. The sensor element according to claim 1, wherein
said inner leading-end protective layer has a porosity of 40% to 80%, and
said outer leading-end protective layer has a porosity of 10% to 40%.

3. The sensor element according to claim 1, wherein
said inner leading-end protective layer has a thickness of 300 μm to 800 μm, and
said outer leading-end protective layer has a thickness of 50 μm to 300 μm.

4. The sensor element according to claim 2, wherein
said inner leading-end protective layer has a thickness of 300 μm to 800 μm, and
said outer leading-end protective layer has a thickness of 50 μm to 300 μm.
